(19) United States
(12) Patent Application Publication
(10) Pub. No.: US 2004/0054525 A1
(43) Pub. Date: Mar. 18, 2004

(54) Encoding method and decoding method for digital voice data

(76) Inventor: Hiroshi Sekiguchi, Tokyo (JP)

Correspondence Address: MORGAN LEWIS & BOCKIUS LLP, 1111 PENNSYLVANIA AVENUE NW, WASHINGTON, DC, 20004, US

(21) Appl. No.: 10/466,633

(22) PCT Filed: Jan. 22, 2001
(86) PCT No.: PCT/JP01/00383

(51) Int. Cl. G10L 19/14

(52) U.S. Cl. 704/205

(57) ABSTRACT

The present invention relates to encoding and decoding of digital audio data enabling change of reproducing speed without degradation of articulation of audio while being compatible with various digital contents. In the encoding, a pair of a sine component and a cosine component digitized are generated at each of preset discrete frequencies and, by use of these sine component and cosine component, each of amplitude information items of the sine component and the cosine component is extracted from digital audio data sampled at a predetermined sampling period. Then frame data consisting of pairs of amplitude information items of sine and cosine components extracted corresponding to the respective discrete frequencies is successively generated as part of encoded audio data.

### TECHNICAL FIELD

The present invention relates to methods of encoding and decoding digital audio data sampled at a predetermined period.

### BACKGROUND ART

There are some conventional methods known as time base interpolation and expansion methods of waveform for changing the reproducing speed while maintaining the pitch period and articulation of speech. These techniques are also applicable to speech coding. Namely, speech data, before encoded, is once subjected to time scale compression; and the time scale of the speech data is expanded after decoded, thereby achieving information compression. Basically, the information compression is implemented by thinning a waveform at the pitch period and the compressed information is expanded based on waveform interpolation to insert new wavelets into spaces between wavelets. Techniques for this process include Time Domain Harmonic Scaling (TDHS) and PICOLA (Pointer Interval Control Overlap and Add), which are methods of thinning and interpolation with a triangular window while maintaining the periodicity of speech pitch in the time domain, and methods of thinning and interpolation in the frequency domain by fast Fourier transform. These methods have the problem of handling of nonperiodic and transitional portions, and distortion is likely to occur in the process of expanding quantized speech data on the decoding side.

The method of interpolating wavelets while maintaining the periodicity of speech pitch in preceding and subsequent frames is also effectively applicable to the case when a wavelet or information of one frame is completely missed in packet transmission.

The techniques proposed as improvements in the above waveform interpolation in terms of information compression include encoding methods based on Time Frequency Interpolation (TFI), Prototype Waveform Interpolation (PWI), or more general Waveform Interpolation (WI).

### DISCLOSURE OF THE INVENTION

The Inventor examined the prior art discussed above and found the following problem. Namely, since the conventional speech data encoding methods with the reproducing speed changing function in decoding were configured to encode data with higher priority to the pitch information of speech, they could be applied to processing of speech itself, but could not be applied to digital contents containing sound except for speech, e.g., to music itself, audio with the background of music, and so on. Accordingly, it was the case that the conventional speech data encoding methods with the reproducing speed changing function were applicable only in the limited technical fields of telephone and the like.

The present invention has been accomplished in order to solve the above problem and an object of the invention is to provide encoding and decoding methods of digital audio data for encoding and decoding digital contents (which is typically digital information of sounds, movies, news, etc. mainly containing audio data and which will be referred to as digital audio data) delivered through various data communications and recording media, as well as telephone, while enabling increase in the data compression rate, change of reproducing speed, etc. with the articulation of audio being maintained.

The encoding method of digital audio data according to the present invention enables satisfactory data compression without degradation of the articulation of audio. The decoding method of digital audio data according to the present invention enables easy and free change of reproducing speed without change in interval by making use of the encoded audio data encoded by the encoding method of digital audio data according to the present invention.

The encoding method of digital audio data according to the present invention comprises the steps of: preliminarily setting discrete frequencies spaced at predetermined intervals; based on a sine component and a cosine component paired therewith, the components corresponding to each of the discrete frequencies and each component being digitized, extracting amplitude information items of the pair of the sine component and cosine component at every second period from digital audio data sampled at a first period; and successively generating frame data containing pairs of amplitude information items of the sine and cosine components extracted at the respective discrete frequencies, as part of encoded audio data.

Particularly, in the encoding method of digital audio data, the discrete frequencies spaced at the predetermined intervals are set in the frequency domain of the digital audio data sampled, and a pair of the sine component and cosine component digitized are generated at each of these discrete frequencies. For example, Japanese Patent Application Laid-Open No. 2000-81897 discloses such a technique that the encoding side is configured to divide the entire frequency range into plural bands and extract the amplitude information in each of these divided bands and that the decoding side is configured to generate sine waves with the extracted amplitude information and combine the sine waves generated in the respective bands to obtain the original audio data. The division into the bands is normally implemented by means of digital filters. In this case, as the separation accuracy is enhanced, the amount of processing becomes extremely large; therefore, it was difficult to increase the speed of encoding. In contrast, since the encoding method of digital audio data according to the present invention is configured to generate the pairs of sine and cosine components at the respective discrete frequencies among all the frequencies and extract the amplitude information items of the respective sine and cosine components, the method makes it feasible to increase the speed of the encoding process.

In the encoding method of digital audio data, specifically, the digital audio data is multiplied by each of a sine component and a cosine component paired with each other, at every second period relative to the first period of the sampling period, thereby extracting each amplitude information as a direct current component in the result of the multiplication. When the amplitude information of the sine and cosine components paired at each of the discrete frequencies is utilized in this way, the resultant encoded audio data comes to contain phase information as well. The above second period does not need to be equal to the first period being the sampling period of digital audio data, and this second period is the reference period of the reproduction period on the decoding side.

In the present invention, as described above, the encoding side is configured to extract both the amplitude information of the sine component and the amplitude information of the cosine component at one frequency and the decoding side is configured to generate the digital audio data by making use of these amplitude information items; therefore, it is also feasible to transmit the phase information at the frequency and achieve the quality of sound with better articulation. Namely, the encoding side doe not have to perform the process of cutting out a waveform of digital audio data as required before, so that the continuity of sound is maintained; and the decoding side is configured without the processing in cutout units of the waveform, so as to ensure the continuity of waveform both in the case of the reproducing speed not being changed, of course, and in the case of the reproducing speed being changed, thereby achieving excellent articulation and quality of sound. However, since the human auditory sensation is scarcely able to discriminate phases in the high frequency domain, it is less necessary to also transmit the phase information in the high frequency domain, and the sufficient articulation of reproduced audio can be ensured therein by only the amplitude information.

Therefore, the encoding method of digital audio data according to the present invention may be configured so that, as to one or more frequencies selected from the discrete frequencies, particularly, as to high frequencies less necessitating the phase information, a square root of a sum component given as a sum of squares of respective amplitude information items of a sine component and a cosine component paired with each other is calculated at each frequency selected and so that the square root of the sum component obtained from the pair of these amplitude information items replaces the amplitude information pair corresponding to the selected frequency. This configuration realizes the data compression rate of the level comparable to that of MPEG-Audio frequently used in these years.

The encoding method of digital audio data according to the present invention can also be arranged to thin insignificant amplitude information in consideration of the human auditory sensation characteristics, thereby raising the data compression rate. An example is a method of intentionally thinning data that is unlikely to be perceived by humans, e.g., frequency masking or time masking; for example, a potential configuration is such that, in the case where an entire amplitude information string in frame data is comprised of pairs of amplitude information items of sine and cosine components corresponding to the respective discrete frequencies, comparison is made between or among square roots of sum components (each being a sum of squares of an amplitude information item of a sine component and an amplitude information item of a cosine component) of two or more amplitude information pairs adjacent to each other and the amplitude information pair or pairs other than the amplitude information pair with the maximum square root of the sum component out of the amplitude information pairs thus compared are eliminated from the frame data. In the case where part of the amplitude information string in the frame data is comprised of the amplitude information containing no phase information (which consists of the square roots of the sum components and which will be referred to hereinafter as square root information), it is also possible to employ a configuration wherein comparison is made between or among two or more square root information pieces adjacent to each other and wherein the square root information piece or pieces other than the maximum square root information out of those square root information pieces compared are eliminated from the frame data, just as in the above case of the adjacent amplitude information pairs (all containing the phase information). In either of the above configurations, the data compression rate can be remarkably increased.

The recent spread of audio delivery systems using the Internet and others increased chances of once storing delivered audio data (digital information mainly containing human speech, such as news programs, discussion meetings, songs, radio dramas, language programs, and so on) in recording media such as hard disks and semiconductor memories and thereafter reproducing the delivered audio data therefrom. Particularly, the presbycusis includes a type of people having difficulties in hearing at high speaking rates. There is also a strong need for a slowdown of speaking speed in a language as a learning target in the learning process of foreign languages.

Under the social circumstances as described above, if delivery of digital contents to which the encoding method and decoding method of digital audio data according to the present invention are applied is realized, the users will be allowed to arbitrarily adjust the reproducing speed without change in the interval of reproduced audio (to increase or decrease the reproducing speed). In this case, the users can increase the reproducing speed in portions that they do not desire to listen to in detail (the users can adequately understand the contents even at approximately double the normal reproducing speed, because the interval is not changed) and can instantaneously return to the original reproducing speed or to a slower reproducing speed than it, in portions that they desire to listen to in detail.

Specifically, the decoding method of digital audio data according to the present invention is configured so that, in the case where an entire amplitude information string of frame data encoded as described above (which constitutes part of encoded audio data) is comprised of pairs of amplitude information items of sine and cosine components corresponding to respective discrete frequencies, the method comprises the steps of: first successively generating a sine component and a cosine component paired therewith, digitized at a third period, at each of the discrete frequencies and then successively generating digital audio data, based on amplitude information pairs and pairs of generated sine and cosine components corresponding to the respective discrete frequencies in the frame data retrieved at a fourth period of a reproduction period (which is set on the basis of the second period).

On the other hand, in the case where part of the amplitude information string of the frame data is comprised of amplitude information containing no phase information (square roots of sum components given by sums of squares of amplitude information items of sine and cosine components paired), the decoding method of digital audio data according to the present invention comprises the step of successively generating digital audio data, based on the sine or cosine components digitized at the respective discrete frequencies and on square roots of sum components corresponding thereto.

The above decoding methods both can be configured to successively generate one or more amplitude interpolation information pieces at a fifth period shorter than the fourth period, so as to effect linear interpolation or curve function interpolation of amplitude information between frame data retrieved at the fourth period.

Each of the embodiments according to the present invention can be fully understood in view of the detailed description and accompanying drawings which will follow. It is to be understood that these embodiments are presented simply for the purpose of illustration but not for the purpose of limitation of the invention.

The scope of further application of the present invention will become apparent from the detailed description below. It is, however, noted that the detailed description and specific examples will demonstrate the preferred embodiments of the present invention and be presented only for the purpose of illustration and it is apparent that various modifications and improvements within the spirit and scope of the present invention are obvious to those skilled in the art in view of the detailed description.

### BRIEF DESCRIPTION OF THE DRAWINGS

FIG. 1A and FIG. 1B are illustrations for conceptually explaining each embodiment according to the present invention (No. 1).

FIG. 2 is a flowchart for explaining the encoding method of digital audio data according to the present invention.

FIG. 3 is an illustration for explaining digital audio data sampled at a period Δt.

FIG. 4 is a conceptual diagram for explaining the process of extracting each amplitude information from pairs of sine and cosine components corresponding to the respective discrete frequencies.

FIG. 5 is an illustration showing a first configuration example of frame data constituting part of encoded audio data.

FIG. 6 is an illustration showing a configuration of encoded audio data.

FIG. 7 is a conceptual diagram for explaining encryption.

FIG. 8A and FIG. 8B are conceptual diagrams for explaining a first embodiment of data compression effected on frame data.

FIG. 9 is an illustration showing a second configuration example of frame data constituting part of encoded audio data.

FIG. 10A and FIG. 10B are conceptual diagrams for explaining a second embodiment of data compression effected on frame data and, particularly, FIG. 10B is an illustration showing a third configuration example of frame data constituting part of encoded audio data.

FIG. 11 is a flowchart for explaining the decoding process of digital audio data according to the present invention.

FIG. 12A, FIG. 12B, and FIG. 13 are conceptual diagrams for explaining data interpolation of digital audio data to be decoded.

FIG. 14 is an illustration for conceptually explaining each embodiment according to the present invention (No. 2).

### BEST MODE FOR CARRYING OUT THE INVENTION

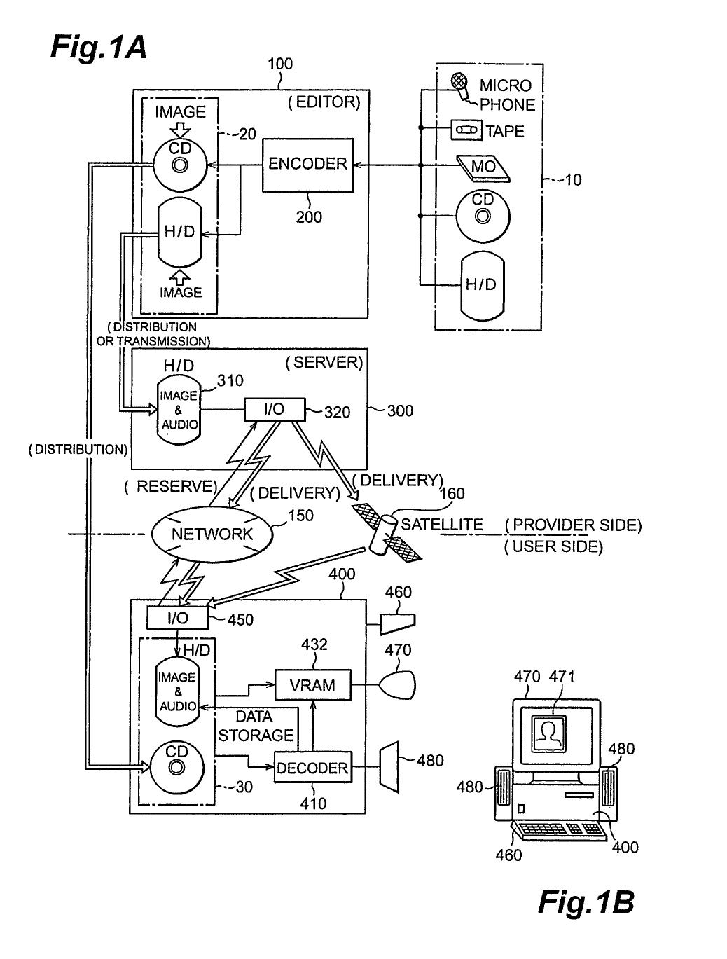

Each of embodiments of the data structure and others of audio data according to the present invention will be described below with reference to FIGS. 1A-1B, 2-7, 8A-8B, 9, 10A-10B, 11, 12A-12B, and 13-14. The same portions will be denoted by the same reference symbols throughout the description of drawings, without redundant description.

The encoded audio data encoded by the encoding method of digital audio data according to the present invention enables the user to implement decoding of new audio data for reproduction at a reproduction speed freely set by the user, without degradation of articulation (easiness to hear) during reproduction. Various application forms of such audio data can be contemplated based on the recent development of digital technology and improvement in data communication environments. FIGS. 1A and 1B are conceptual diagrams for explaining how the encoded audio data will be utilized in industries.

As shown in FIG. 1A, the digital audio data as an object to be encoded by the encoding method of digital audio data according to the present invention is supplied from a source of information 10. The source of information 10 is preferably one supplying digital audio data recorded, for example, in an MO, a CD (including a DVD), an H/D (hard disk), or the like and the data can also be, for example, audio data provided from educational materials commercially available, TV stations, radio stations, and so on. Other applicable data is one directly taken in through a microphone, or one obtained by digitizing analog audio data once recorded in a magnetic tape or the like, before the encoding process. An editor 100 encodes the digital audio data to generate encoded audio data through the use of the source 10 in an encoder 200, which includes information processing equipment such as a personal computer. On this occasion, in view of the current data providing methods, the encoded audio data thus generated is often provided to the users in a state in which the data is once recorded in a recording medium 20 such as a CD (including a DVD), an H/D, or the like. It can also be probably contemplated that those CD and H/D contain a record of related image data together with the encoded audio data.

Particularly, the CDs and DVDs as recording media 20 are generally provided as supplements to magazines to the users or sold at stores like computer software applications, music CDs, and so on (distributed in the market). It is also probable that the encoded audio data generated is delivered from server 300 through information communication means, e.g., network 150 such as the Internet, cellular phone networks, and the like, regardless of either wired or wireless means, and satellite 160 to the users.

For delivery of data, the encoded audio data generated by the encoder 200 is once stored along with image data or the like in a storage device 310 (e.g., an H/D) in the server 300. Then the encoded audio data (which may be encrypted) once stored in H/D 310 is transmitted through transceiver 320 (I/O in the figure) to user terminal 400. On the user terminal 400 side, the encoded audio data received through transceiver 450 is once stored in an H/D (included in an external storage device 30). On the other hand, in the case of provision of data through the use of the CD, DVD, or the like, the CD purchased by the user is mounted on a CD drive or a DVD drive of terminal device 400 to be used as external recording device 30 of the terminal device.

Normally, the user-side terminal device 400 is equipped with an input device 460, a display 470 such as a CRT, a liquid-crystal display, or the like, and speakers 480, and the encoded audio data recorded together with the image data or the like in the external storage device 300 is once decoded into audio data of a reproducing speed personally designated by the user, by decoder 410 of the terminal device 400 (which can also be implemented by software) and thereafter is outputted from the speakers 480. On the other hand, the image data stored in the external storage 300 is once uncompressed in VRAM 432 and thereafter displayed frame by frame on the display 470 (bit map display). If several types of digital audio data for reproduction at different reproducing speeds are prepared in the external storage 30 by successively storing the digital audio data for reproduction decoded by the decoder 410, in the external storage 30, the user will be allowed to implement switchover reproduction among the plural types of digital audio data of different reproducing speeds by making use of the technology as described in Japanese Patent No. 2581700.

The user can listen to the audio outputted from the speakers 480 while displaying the related image 471 on the display 470, as shown in FIG. 1B. If a change should be made only in the reproducing speed of audio on this occasion, the display timing of the image could deviate. Therefore, for permitting the decoder 410 to control the display timing of image data, information to indicate the image display timing may be preliminarily added to the encoded audio data generated in the encoder 200.

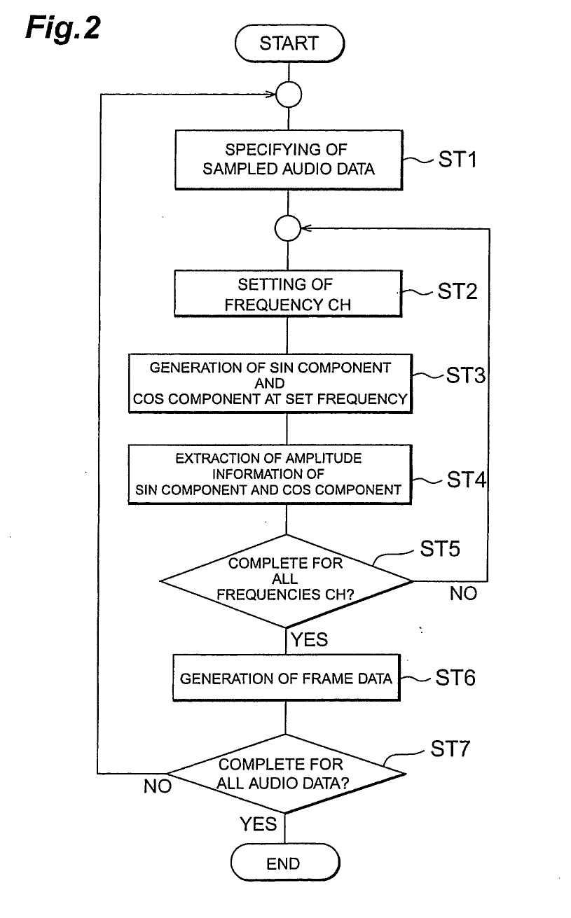

FIG. 2 is a flowchart for explaining the encoding method of digital audio data according to the present invention, and the encoding method is executed in the information processing equipment in the encoder 200 to enable fast and satisfactory data compression without degradation of articulation of audio.

In the encoding method of digital audio data according to the present invention, the first step is to specify digital audio data sampled at the period Δt (step ST1) and the next step is to set one of discrete frequencies (channels CH) at which the amplitude information should be extracted (step ST2).

It is generally known that audio data contains a huge range of frequency components in a frequency spectrum thereof. It is also known that phases of audio spectral components at respective frequencies are not constant and thus there exist two components of a sine component and a cosine component as to an audio spectral component at one frequency.

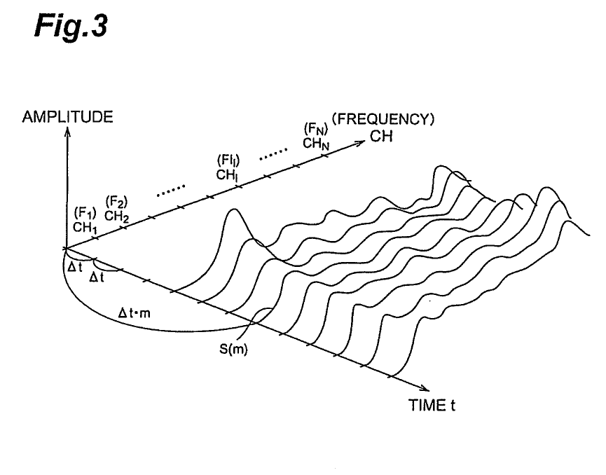

FIG. 3 is an illustration showing audio spectral components sampled at the period Δt, with a lapse of time. Supposing each audio spectral component is expressed by signal components at a finite number of channels CHi (discrete frequencies Fi: i=1, 2, . . . , N) in the entire frequency domain, the mth sampled audio spectral component S(m) (an audio spectral component at a point when the time (Δt·m) has elapsed since the start of sampling) is expressed as follows.

$$S ( m ) = {\sum }_{i = 1}^{N} ( {A}_{i} \cdot sin ( 2 π {F}_{i} ( Δ t \cdot m ) ) + {B}_{i} \cdot cos ( 2 π {F}_{i} ( Δ t \cdot m ) ) ) \qquad ( 1 )$$

Above Eq (1) indicates that the audio spectral component S(m) is comprised of N frequency components, the first to Nth components. Real audio information contains a thousand or more frequency components.

The encoding method of digital audio data according to the present invention has been accomplished on the basis of the Inventor's finding of the fact that from the property of human auditory sensation characteristics, the articulation of audio and the quality of sound remained practically unaffected even if the encoded audio data was represented by the finite number of discrete frequency components.

In the subsequent step, concerning the mth sampled digital audio data (having the audio spectral component S(m)) specified in step ST1, the processor extracts a sine component, sin(2πFi(Δt·m)), and a cosine component, cos(2πFi(Δt·m)), digitized at the frequency Fi (channel CHi) set in step ST2 (step ST3); and the processor further extracts amplitude information items Ai, Bi of the respective sine component and cosine component (step ST4). The steps ST3-ST4 are carried out for all the N channels (step ST5).

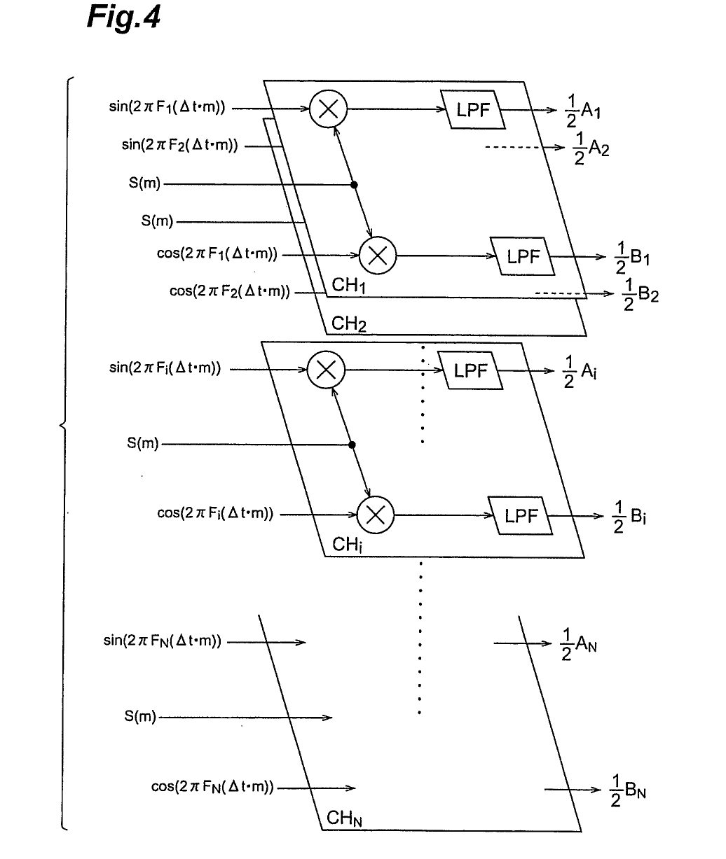

FIG. 4 is an illustration conceptually showing the process of extracting pairs of amplitude information items Ai and Bi at the respective frequencies (channels CH). Since the audio spectral component S(m) is expressed as a synthetic wave of the sine and the cosine components at the frequencies Fi, as described above, multiplication of the audio spectral component S(m) by the sine component of sin(2πFi(Δt·m)), for example, as a process for the channel CHi results in obtaining the square term of sin(2πFi(Δt·m)) with the coefficient of Ai and the other wave component (alternating current component). The square term can be divided into a direct current component and an alternating current component as in general equation (2) below.

sin²θ=½−cos 2θ/2 (2)

Therefore, using a low-pass filter LPF, the direct current component, i.e., the amplitude information Ai/2 can be extracted from the result of the multiplication of the audio spectral component S(m) by the sine component of sin(2πFi(Δt·m)).

The amplitude information of the cosine component can also be obtained similarly so that the direct current component, i.e., the amplitude information Bi/2 is extracted from the result of multiplication of the audio spectral component S(m) by the cosine component of cos(2πFi(Δt·m)), using a low-pass filter LPF.

These amplitude information items are sampled at a period T_{V} (=Δt·v: v is an arbitrary value) lower than the foregoing sampling period, e.g., at 50-100 samples/sec to generate frame data 800a, for example, of structure as shown in FIG. 5. FIG. 5 is a diagram showing a first configuration example of the frame data, in which the frame data is comprised of pairs of amplitude information items Ai of sine components and amplitude information items Bi of cosine components corresponding to the respective frequencies Fi preliminarily set, and control information such as the sampling rate of amplitude information used as a reference frequency for reproduction periods. For example, supposing the audio band is defined by six octaves of 110 Hz-7000 Hz and the channels CH are set to be twelve frequencies per octave so as to match the temperament of music, seventy two (=N) frequency channels CH are set in total in the audio band. Supposing one byte is assigned to each of the amplitude information items at each frequency channel CH and eight bytes to the control information CD, the resultant frame data 800a is of 152 (=2N+8) bytes.

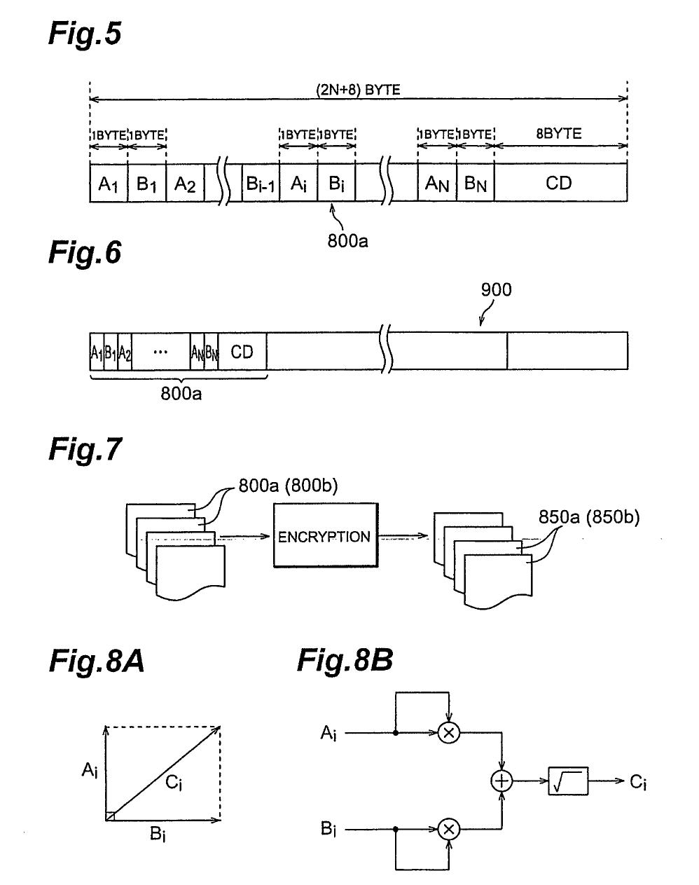

In the encoding method of digital audio data according to the present invention, the aforementioned steps ST1-ST6 are carried out for all the digital audio data sampled, to generate the frame data 800a of the structure as described above and finally generate the encoded audio data 900 as shown in FIG. 6 (step ST7).

Since the encoding method of digital audio data is configured to generate the pair of the sine component and cosine component at each of the discrete frequencies out of all the frequencies and extract the amplitude information items of the sine component and cosine component as described above, it enables increase in the speed of the encoding process. Since the frame data 800a forming part of the encoded audio data 900 is comprised of the amplitude information items Ai, Bi of the respective sine and cosine components paired at the respective discrete frequencies Fi, the encoded audio data 900 obtained contains the phase information. Furthermore, there is no need for the process of windowing to cut frequency components out of the original audio data, so that the continuity of audio data can be maintained.

The encoded audio data 900 obtained can be provided to the user through the network or the like as shown in FIG. 1A; in this case, as shown in FIG. 7, it is also possible to encrypt each frame data 800a and deliver encoded audio data consisting of the encrypted data 850a. While FIG. 7 shows the encryption in frame data units, it is, however, also possible to employ an encryption process of encrypting the entire encoded audio data all together or an encryption process of encrypting only one or more portions of the encoded audio data.

In the present invention, the encoding side is configured to extract both the amplitude information of the sine component and the amplitude information of the cosine component at one frequency and the decoding side is configured to generate the digital audio data by use of these information pieces; therefore, the phase information at the frequency can also be transmitted, so as to achieve the quality of sound with better articulation. However, the human auditory sensation is scarcely able to discriminate phases in the high frequency domain; it is thus less necessary to also transmit the phase information in the high frequency domain and the satisfactory articulation of reproduced audio can be ensured by only the amplitude information.

Therefore, the encoding method of digital audio data according to the present invention may also be configured to, concerning one or more frequencies selected from the discrete frequencies, particularly, concerning high frequencies less necessitating the phase information, calculate a square root of a sum component given as a sum of squares of the respective amplitude information items of the sine and cosine components paired with each other, at each selected frequency and replace an amplitude information pair corresponding to the selected frequency in the frame data with the square root of the sum component obtained from the amplitude information pair.

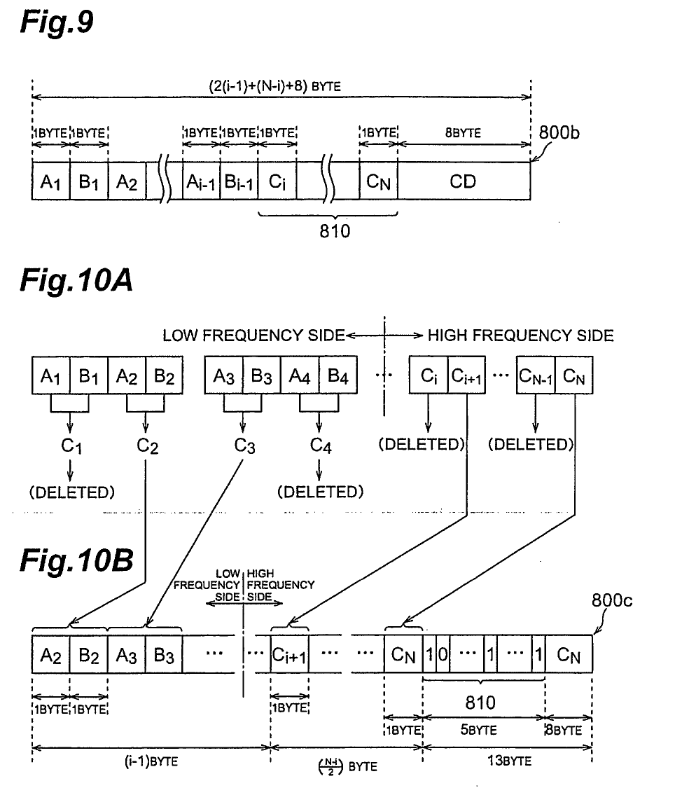

Namely, let us consider mutually orthogonal vectors representing the paired amplitude information items Ai, Bi, as shown in FIG. BA; then the square root Ci of the sum component given by the sum of squares of the respective amplitude information items Ai, Bi is obtained by an arithmetic circuit as shown in FIG. 8B. Compressed frame data is obtained by replacing an amplitude information pair corresponding to each high frequency with the square root information Ci obtained as described above. FIG. 9 is an illustration showing a second configuration example of the frame data is resulting from omission of the phase information as described above.

For example, suppose the amplitude information pair is replaced by the square root information Ci at each of twenty four frequencies on the high frequency side out of the pairs of amplitude information items of sine and cosine components at seventy two frequencies; where each of the amplitude information and square root information is assigned one byte and the control information CD eight bytes, the frame data 800b is of 128 (=2×48+24+8) bytes. Therefore, when compared with the frame data 800b shown in FIG. 5, the data compression rate is achieved at the level comparable to that of MPEG-Audio frequently used in recent years.

In FIG. 9, area 810 in the frame data 800b is an area in which the square root information Ci replaces the amplitude information pairs. This frame data 800b may also be encrypted so as to be able to be delivered as contents, as shown in FIG. 7.

Furthermore, the encoding method of digital audio data according to the present invention can also be configured to thin some of the amplitude information pairs constituting one frame data, whereby the data compression rate can be raised more. FIGS. 10A and 10B are illustrations for explaining an example of the data compressing method involving the thinning of the amplitude information. Particularly, FIG. 10B is an illustration showing a third configuration example of the frame data obtained by the data compressing method. This data compressing method can be applied to both of the frame data 800a shown in FIG. 5 and the frame data 80b shown in FIG. 9, and the following is a description of compression of the frame data 800b shown in FIG. 9.

First, concerning the portion comprised of pairs of amplitude information items of sine and cosine components in the amplitude information string in the frame data 800b, square root information items C₁, C₂, . . . , Cᵢ₋₁ of respective pairs are calculated in each set of amplitude information pairs adjacent to each other, e.g., in each of the set of (A₁,B₁) and (A₂,B₂), the set of (A₃,B₃) and (A₄,B₄), . . . , the set of (Aᵢ₋₂,Bᵢ₋₂) and (Aᵢ₋₁,Bᵢ₋₁) and, instead of comparison between adjacent amplitude information pairs, comparison is made between the resultant square root information items C₁ and C₂, C₃ and C₄, . . . , Ciᵢ₋₂ and Cᵢ₋₁. In each of the above sets, the pair with the greater square root information is left. The above comparison may also be made among each set of three or more amplitude information pairs adjacent to each other.

In this case, as shown in FIG. 10B, a discrimination bit string (discrimination information) is prepared in the frame data 800c, in which 0 is set as a discrimination bit if the left amplitude information pair is a lower-frequency-side amplitude information pair and in which 1 is set as a discrimination bit if the left amplitude information pair is a higher-frequency-side amplitude information pair.

On the other hand, in the case where the amplitude information pairs have previously been replaced by the square root information items, as in the region 810 cf. FIG. 9), comparison is made between Cᵢ and Cᵢ₊₁, . . . , between C_{N-1} and C_{N}, and the greater is left. In this case, 0 is also set as a discrimination bit if the lower-frequency-side square root information is left, while 1 is also set as a discrimination bit if the higher-frequency-side square root information is left. The above comparison may also be made among each set of three or more square root information items adjacent to each other.

For example, in the case where the frame data 800b shown in FIG. 9 is comprised of forty eight amplitude information pairs (one byte for each amplitude information item) and twenty four square root information items (one byte for each item) as described above, the amplitude information string is reduced to 48 bytes (=2×24) and the square root information string to 12 bytes; however, 36 bits (4.5 bytes) are necessary for discrimination bits on the other hand. Accordingly, in the case where the amplitude information items of the respective sine and cosine components are extracted at seventy two frequencies, the frame data 800c consists of the amplitude information string of 60 (=2×24+1×12) bytes, the discrimination information of approximately 5 (≈4.5) bytes, and the control information of 8 bytes (73 bytes in total). Under the same conditions the frame data 800b shown in FIG. 9 is of 128 bytes and, therefore, data can be cut by about 43%.

This frame data 800c may also be encrypted as shown in FIG. 7.

The recent spread of audio delivery systems using the Internet and others increased the chances of once storing delivered audio data (digital information mainly containing human speech, such as news programs, discussion meetings, songs, radio dramas, language programs, and so on) in recording media such as hard disks and others and thereafter reproducing the delivered audio data therefrom. Particularly, the presbycusis includes a type of people having difficulties in hearing at high speaking rates. There is also a strong need for a slowdown of speaking speed in a language as a learning target in the learning process of foreign languages.

Under the social circumstances as described above, if delivery of digital contents to which the encoding method and decoding method of digital audio data according to the present invention are applied is realized, the users will be allowed to arbitrarily adjust the reproducing speed without change in the interval of reproduced audio (to increase or decrease the reproducing speed). In this case, the users can increase the reproducing speed in portions that they do not desire to listen to in detail (the users can adequately understand the contents even at approximately double the normal reproducing speed, because the interval is not changed) and can instantaneously return to the original reproducing speed or to a slower reproducing speed than it, in portions that they desire to listen to in detail.

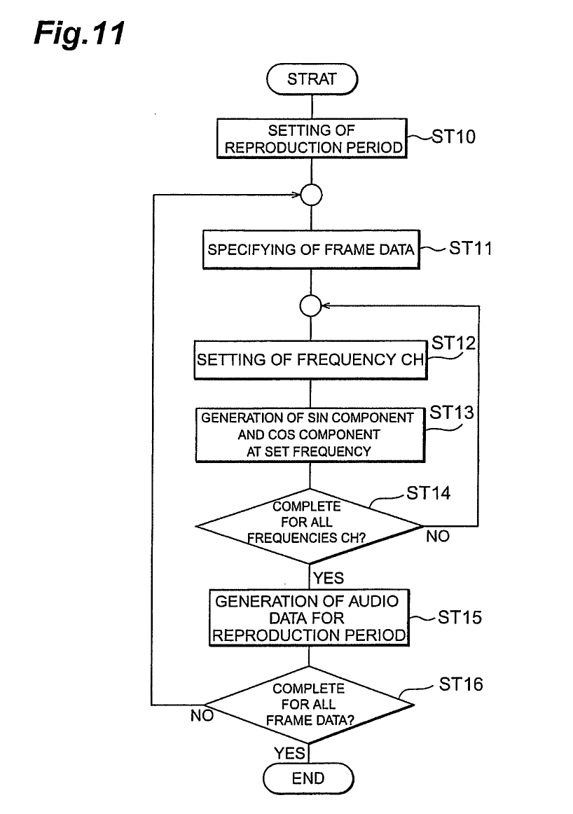

FIG. 11 is a flowchart for explaining the decoding method of digital audio data according to the present invention, which enables easy and free change of speech speed without change in the interval, by making use of the encoded audio data 900 encoded as described above.

In the decoding method of digital audio data according to the present invention, the first step is to set the reproduction period T_{W}, i.e., the period at which the frame data is successively retrieved from the encoded data stored in the recording medium such as the H/D (step ST10), and the next step is to specify the nth frame data to be decoded (step ST11). This reproduction period T_{W} is given by the ratio (T_{V}/R) of the sampling period T_{V} (=Δt·v: v is an arbitrary value) of the amplitude information in the above-stated encoding process to a reproducing speed ratio R designated by the user (on the basis of 1, R=0.5 represents a half speed and R=2 a double speed).

Subsequently, a channel CH of frequency Fi (i=1−N) is set (step ST12), and the sine component of sin(2πFi(Δτ·n)) and the cosine component of cos(2πFi(Δτ·n)) are successively generated at each frequency Fi (steps ST13 and ST14).

Then the digital audio data at the point when the time (Δτ·n) has elapsed since the start of reproduction is generated based on the sine and cosine components at the respective frequencies Fi generated in step ST13 and the amplitude information items Ai, Bi in the nth frame data specified in step ST11 (step ST15).

The above steps ST11-ST15 are carried our for all the frame data included in the encoded audio data 900 (cf. FIG. 6) (step ST16).

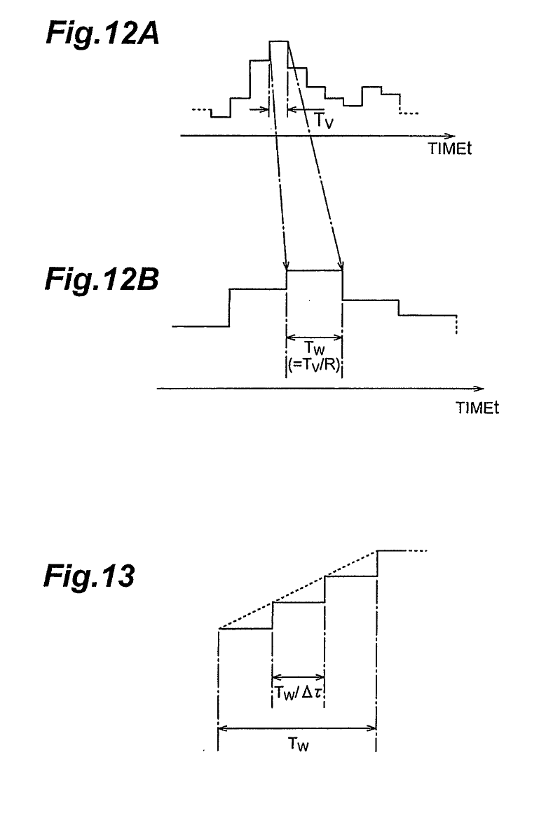

In the case where the frame data specified in step ST11 contains the square root information Ci as in the frame data 800b shown in FIG. 9, the process may be carried out by using the information Ci as a coefficient for either of the sine component and the cosine component. The reason is that the frequency domain involving the replacement with the information Ci is a frequency region in which humans are unlikely to be able to discriminate them and it is thus less necessary to discriminate the sine and cosine components from each other. If part of the amplitude information is missing in the frame data specified in step ST11, just as in the frame data 800c shown in FIG. 10B, a decrease of the reproducing speed will result in making the discontinuity of reproduced audio outstanding, as shown in FIGS. 12A and 12B. For this reason, as shown in FIG. 13, it is preferable to divide the interval of the reproduction period T_{W} into (T_{W}/Δτ) zones and effect linear interpolation or curve function interpolation between preceding and subsequent audio data pieces. In this case, T_{W}/Δτ times the original audio data items are generated.

When a one-chipped processor dedicated to the decoding method of digital audio data according to the present invention, as described above, is incorporated into a portable terminal such as a cellular phone, the user is allowed to reproduce the contents or make a call at a desired speed while moving.

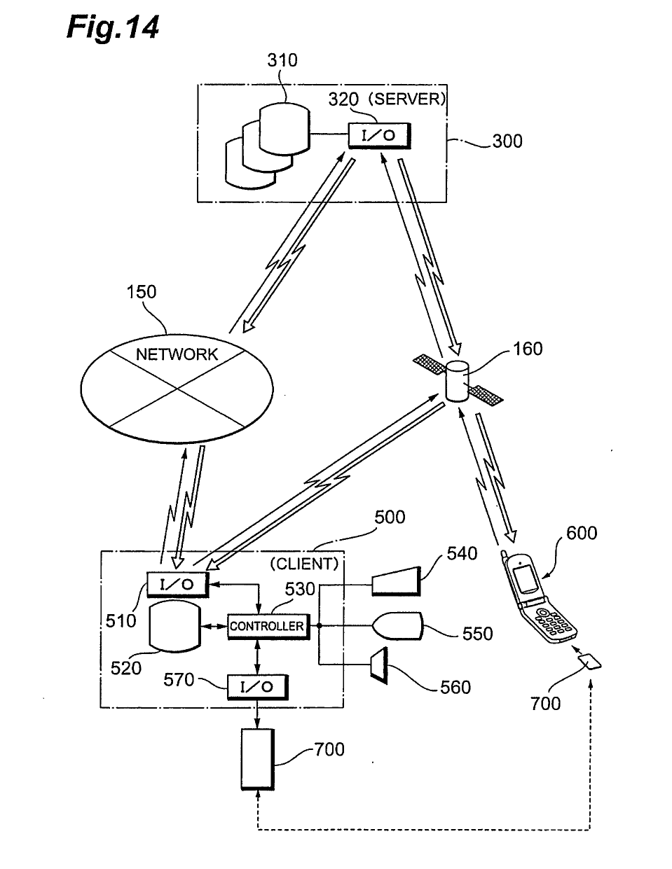

FIG. 14 is an illustration showing an application in a global-scale data communication system for delivery of data to a terminal device requesting the delivery, which is configured to deliver the content data designated by the terminal device, from a specific delivery system such as a server through a wired or wireless communication line to the terminal device, and which mainly enables specific contents such as music, images, etc. to be individually provided to the users through the communication lines typified by the Internet transmission circuit network such as cable television networks and public telephone networks, the radio circuit networks such as cellular phones, the satellite communication lines, and so on. This application of the content delivery system can be substantialized in a variety of conceivable modes thanks to the recent development of digital technology and improvement in the data communication environments.

In the content delivery system, as shown in FIG. 14, the server 100 as a delivery system is provided with a storage device 110 for temporarily storing the content data (e.g., encoded audio data) for delivery according to a user's request; and a data transmitter 120 (I/O) for delivering the content data to the user-side terminal device such as PC 200 or cellular phone 300 through wired network 150 or through a radio link using communication satellite 160.

As the terminal device (client), PC 200 is provided with a receiver 210 (I/O) for receiving the content data delivered from the server 100 through the network 150 or communication satellite 160. The PC 200 is also provided with a hard disk 220 (H/D) as an external storage, and a controller 230 temporarily records the content data received through I/O 210, into the H/D 220. Furthermore, the PC 200 is equipped with an input device 240 (e.g. a keyboard and a mouse) for accepting entry of operation from the user, a display device 250 (e.g., a CRT or a liquid-crystal display) for displaying image data, and speakers 260 for outputting audio data or music data. The recent remarkable development of mobile information processing equipment has brought the content delivery services using cellular phones as terminal equipment and storage media 400 for dedicated reproducing apparatus without the communication function (e.g., memory cards having the memory capacity of about 64 MB) into practical use. Particularly, in order to provide the recording medium 400 used in a reproduction only device without the communication function, the PC 200 may also be equipped with I/O 270 as a data recorder.

The terminal device may be a portable information processing device 300 with the communication function per se, as shown in FIG. 14.

Industrial Applicability

As described above, the present invention has permitted the remarkable increase of processing speed, as compared with the conventional band separation techniques using the band-pass filters, thanks to the following configuration: the amplitude information items of the sine and cosine components were extracted by making use of the pair of the sine component and cosine component corresponding to each of the discrete frequencies, from the digital audio data sampled. Since the encoded audio data generated contains the pairs of amplitude information items of sine and cosine components corresponding to the respective discrete frequencies preliminarily set, the phase information at each discrete frequency is preserved between the encoding side and the decoding side. Accordingly, the decoding side is also able to reproduce the audio at an arbitrarily selected reproducing speed without degradation of articulation of audio.

1. An encoding method of digital audio data comprising the steps of:
setting discrete frequencies spaced at predetermined intervals in a frequency domain of digital audio data sampled at a first period;
by use of a sine component and a cosine component paired therewith corresponding to each of the discrete frequencies thus set, the components being digitized, extracting amplitude information items of the pair of the sine component and cosine component at every second period from the digital audio data; and
successively generating frame data containing pairs of amplitude information items of the sine and cosine components corresponding to the respective discrete frequencies, as part of encoded audio data.

2. An encoding method of digital audio data according to claim 1, wherein each of the amplitude information items of the sine component and cosine component corresponding to each of the discrete frequencies is extracted by multiplying the digital audio data by either of the sine component and cosine component.

3. An encoding method of digital audio information according to claim 1, further comprising the steps of:
for one or more frequencies selected from the discrete frequencies, calculating a square root of a sum component given as a sum of squares of the respective amplitude information items of the sine and cosine components paired with each other, at each selected frequency; and
replacing an amplitude information pair corresponding to each selected frequency, included in the frame data, with the square root of the sum component obtained from the amplitude information pair.

4. An encoding method of digital audio data according to claim 1, further comprising the step of:
thinning one or more amplitude information out of the amplitude information included in the frame data.

5. An encoding method of digital audio data according to claim 1, further comprising the steps of:
between or among amplitude information pairs corresponding to two or more discrete frequencies adjacent to each other, included in the frame data, comparing square roots of sum components given as sums of squares of respective amplitude information items of sine and cosine components paired with each other; and
deleting the amplitude information pairs other than the amplitude information pair with the maximum square root of the sum component among the two or more amplitude information pairs thus compared, from the frame data included in the encoded audio data.

6. An encoding method of digital audio data according to claim 3, further comprising the steps of:
between or among amplitude information pairs corresponding to two or more discrete frequencies adjacent to each other, included in the frame data, comparing the square roots of the sum components; and
deleting the amplitude information pairs other than the amplitude information pair with the maximum square root of the sum component among the two or more amplitude information pairs thus compared, from the frame data included in the encoded audio data.

7. A decoding method of digital audio data for decoding encoded audio data encoded by an encoding method of digital audio data according to claim 1, said decoding method comprising the steps of:
successively generating a sine component and a cosine component paired therewith, digitized at a third period, at each of the discrete frequencies; and
as to each of frame data successively retrieved at a fourth period of a reproduction period out of the encoded audio data, successively generating digital audio data by use of amplitude information pairs corresponding to the respective discrete frequencies included in the frame data retrieved and pairs of the sine and cosine components.

8. A decoding method of digital audio data according to claim 7, wherein the frame data is arranged as to each of one or more frequencies selected from the discrete frequencies so that a pair of amplitude information items of the sine and cosine components paired with each other is replaced by a square root of a sum component given as a sum of squares of said amplitude information items, and
wherein part of the digital audio data obtained by the encoding method is generated by use of the square root of the sum component in the frame data, and either of the sine component and the cosine component corresponding to the frequency to which the square root of the sum component belongs.

9. A decoding method of digital audio data according to claim 7 or 8, wherein one or more amplitude interpolation information is successively generated at a fifth period shorter than the fourth period so as to effect linear interpolation or curve function interpolation of amplitude information between frame data successively retrieved at the fourth period.
